(19) United States
(12) Patent Application Publication
(10) Pub. No.: US 2012/0043400 A1
(43) Pub. Date: Feb. 23, 2012

(54) ATOMIZER FOR LIQUIDS, METHOD FOR THE MANUFACTURE THEREOF, AND USE THEREOF

(76) Inventors: Joerg Heyse, Besigheim (DE); Martin Maier, Moeglingen (DE)

(21) Appl. No.: 13/144,472

(22) PCT Filed: Jan. 11, 2010
(86) PCT No.: PCT/EP2010/050209

§ 371 Date: Nov. 1, 2011

(30) Foreign Application Priority Data
Jan. 17, 2009 (DE) 102009005026.4

(51) Int. Cl. B05B 1/18; B21D 51/16

(52) U.S. Cl. 239/567; 29/890.09

(57) ABSTRACT

An atomizer is described for liquids, in particular for delivering water in a shower, having an outlet on a liquid supply line for spraying liquids at a low flow rate, the outlet having at least two nozzles for generating liquid jets and for atomizing. The present atomizer is based on the object of optimizing a washing device for delivering water, in particular in a shower, and providing a cost-effective embodiment of a shower head. The atomizer is characterized in that at least one atomizer attachment is provided, which includes at least one atomizer plate, which is convexly curved in the jet direction, and is inserted into the outlet, and at least one slot or multiple slots positioned in parallel directions to one another are introduced into the atomizer plate. The atomizer plate, which is convexly curved in the jet direction, is bent in a shell shape and/or channel shape.

### FIELD OF THE INVENTION

The present invention relates to an atomizer for liquids. Furthermore, the present invention includes a method for manufacturing an atomizer for liquids, in particular for delivering water in a shower, and the use thereof.

### BACKGROUND INFORMATION

A generic atomizer for liquids includes, for example, a washing device from WO 2004/101163 A1. A shower head is discussed therein, in which water nozzles are positioned in pairs, so that the jets from two nozzles of a pair impact one another and thus dissolve into droplets. The purpose of the device is to allow a pleasant showering experience at various operating pressures between 2.0 bar and 25 bar and also to reduce the water consumption compared to conventional showerheads. However, it is to be prevented that, in addition to the water droplets, a mist made of very fine droplets occurs. For this purpose, the impacting jets may be positioned in such a way that they do not completely overlap one another.

The washing device has an outlet for spraying liquids at a low flow rate and a conveyor for increasing a liquid pressure before the spraying. The sprayed liquid is typically water. However, soap or another detergent or disinfectant may be added to the water. The mixture may come out of all nozzles. It is also possible to supply the nozzles with different liquids in each case, for example, one nozzle with water and the other with soap, or one with water and one with disinfectant. The washing device may also be used in therapeutic, cosmetic, and pharmaceutical fields, in addition to the sanitary field, for example, using admixed cosmetic or medical active ingredients.

Due to the pressure boost it is possible to spray the liquid despite a low flow rate in such a way that a pleasant washing or showering experience results, because the particle size of the water droplets is substantially reduced compared to conventional showers by the spraying at increased pressure and accordingly through narrow nozzles. The total surface area of the water droplets is therefore substantially greater than in the case of the same quantity of water in larger drops, and the effect when wetting the body is accordingly also increased.

The conveyor or pump thus may be positioned locally as part of the washing device, close to the outlet or a shower head, i.e., in a bathroom or as an installed element of a mobile or stationary shower stall. Due to the low water consumption, the washing device is particularly suitable for installation in transportation systems, such as, for example, trains, airplanes, recreational vehicles, or other mobile equipment. Other applications are, for example, in showers or washing facilities in public swimming pools, in dishwashers, or for watering plants.

In addition, the washing device has a heating element for heating the water or the liquid. Thanks to the low flow rate, this heater may be designed to be comparatively small. In particular, it may be designed to be an instantaneous water heater, i.e., without a tank as in the case of a boiler heater. The heater may particularly be operated electrically. Otherwise, the hot water is supplied from a central, heatable hot water tank or in general using stored hot water. Because of the low required heating power, an electric heater may be operated using existing domestic electrical installations. The heater may thus be positioned in a decentralized way, i.e., each shower or washing device having its own heater.

### SUMMARY OF THE INVENTION

It is therefore an object of the exemplary embodiments and/or exemplary methods of the present invention to optimize a washing device for delivering water, in particular in a shower, and to provide a cost-effective design of a shower head.

This is achieved according to the exemplary embodiments and/or exemplary methods of the present invention by the features described herein. Advantageous refinements are provided from the further descriptions herein.

The atomizer is characterized in that at least one atomizer attachment is provided, which includes at least one atomizer plate, which is convexly curved in the jet direction, and is inserted into the outlet. At least one slot or multiple slots positioned in parallel directions to one another is/are introduced into the atomizer plate.

The atomizer plate which is convexly curved in the jet direction is bent in a shell shape and/or channel shape. Especially in the case of an atomizer plate which is convexly curved in the jet direction, the slots are designed to run laterally and/or diagonally interleaved to the channel axis. In a further specific embodiment, the slots may be distributed equidistantly or at different distances to one another on an atomizer plate which is convexly curved in the jet direction. The axes of symmetry of multiple slots, which point in the flow direction, diverge away from one another in the jet direction.

The slots traverse the thickness of the atomizer plate either in the direction of the local surface normal or also diagonally inclined thereto. The length of the slots is predefinable and may be designed identically or differently within an atomizer attachment and/or an atomizer plate. Furthermore, the slots may be positioned identically to one another, in a straight slot row, or offset in the slot longitudinal direction.

In a further specific embodiment, the atomizer plate which is convexly curved in the jet direction is either not curved along the slot row or it has a convex curvature in the jet direction, whose radius of curvature is greater than the radius of curvature transversely over the atomizer plate, which is bent in a channel shape.

The radius of curvature transversely over the atomizer plate which is convexly curved in the jet direction is optionally constant over the length of the slot row, or a varying radius of curvature is provided over the length of the slot row. An atomizer plate which is convexly curved in the jet direction may be rotation-symmetrically curved or its curvature corresponds to the shell cutout of an ellipsoid.

A channel-shaped atomizer plate forms a straight channel having a direction divergence between the slot axes. The slots penetrate the straight channel deviating from the perpendicular to the surface at one location. As an alternative specific embodiment thereto, a channel-shaped atomizer plate may also form a convexly curved channel viewed along its length in the jet direction. In this case, the radius of curvature of the convex curvature along the length of the channel is greater than the radius of curvature transversely over the channel and the slots always run in the direction of the curvature having the smaller radius of curvature.

In a further specific embodiment, a pipe piece having an outwardly bent surface area is used, it being identical in shape to a channel shape and being provided with the slots.

The width of the slots may widen or narrow in the jet direction. The size of the free slot cross section and the shape of the slot cross section may also vary or remain constant in the jet direction. The slot cross section may have an oblong format having an arbitrary cross-sectional shape, in particular having a rectangular, lenticular, or oval cross section.

A supplementary specific embodiment, in particular for shower applications, provides that a further catch plate is mounted upstream from the atomizer plate in the jet direction, and a space is provided between the atomizer plate and the additional catch plate, so that a cavity is formed. At least one opening, which is associated with a slot in the atomizer plate, for the passage of the fan-shaped liquid jets is introduced into this catch plate. The external dimensions of the opening are selected in such a way that the lateral jet edges of each fan jet are prevented from passing by the catch plate and the liquid quantity at the jet edges is collected on the upstream side of the catch plate. The collection of the jet edges is used for the purpose of blocking them out of the liquid jet, since the jet edges have a high jet momentum because of their thickening compared to the lower fan jet lamellar thickness, which otherwise causes unpleasant pressure when it hits the skin during a shower.

The catch plate has an identical or similar convex shape as the atomizer plate or is designed to be level. The catch plate is advantageously positioned at least far enough away from the atomizer plate that individual fan jet lamellae already disintegrate into smaller ligaments before reaching the catch plate. Otherwise, thickened jet edges would again be formed in a still existent lamella on the free side of the catch plate via surface tension action.

In one particular specific embodiment, the collected liquid quantity from the jet edge is sucked off the catch plate and resupplied to the atomizer. An upstream pressure boosting pump or a pump which operates according to the injector principle, for example, a water jet pump in a shower head, is provided for the suction.

The method according to the present invention for manufacturing an atomizer for liquids, in particular for delivering water in a shower, having an outlet on a liquid supply line for spraying liquids at a low flow rate, the outlet having at least two nozzles for generating liquid jets and for atomizing, is characterized in that at least one slot is milled or ground by a disk-shaped tool in at least one atomizer plate, which is convexly curved in the jet direction, of an atomizer attachment, and the tool for introducing the slot is a rotationally symmetrical rotating disk.

The atomizer for liquids according to the exemplary embodiments and/or exemplary methods of the present invention may be used in the field of washer appliances for domestic and industrial applications, firefighting, high-pressure cleaning equipment, furnace and burner technology, and irrigation equipment.

Advantageous properties are: the best-possible atomization quality for showering comfort, the achievable droplet size being able to be reduced by up to one-third as needed without a further pressure boost compared to concepts known from the related art, uniform distribution or targeted variation of the sprayed liquid quantity over a predefined surface, precisely delimited spraying within a predefined spray cross section, higher impact momentum of the liquid jets for the best cleaning effect, water savings as a result of ultrafine atomization, and best cleaning effect due to high impact momentum.

With respect to the wellness area of application, a water-saving, efficiently cleaning shower by efficient, uniform, finely atomized spray distribution at high impact momentum is available. In water technology, for example, a spray arm of dishwashers may be designed in such a way that water savings results through efficient, uniform, finely atomized, and high-momentum distribution on dishes to be cleaned. In firefighting, the essential effect is in efficient extinguishing of flames by forming liquid curtains while covering large areas. High-pressure cleaning equipment having a configuration according to the present invention cleans in an efficient and water-saving way by uniform, finely atomized, and high-momentum distribution of the spray jet. Irrigation equipment operates in a water-saving way and may be used in a targeted way on spatially limited areas. A further area of application is the use of the atomizer as a fountain attachment for garden and indoor fountains. The spray pattern is an aesthetic appearance; in the case of indoor fountains, the room air humidification is very efficient due to the homogeneous distribution of a finely atomized spray. Furthermore, the features according to the exemplary embodiments and/or exemplary methods of the present invention may be transferred to furnace and burner technology. Energy-saving oil burner nozzles may be designed, which ensure a targeted, finely atomized, and stoichiometric distribution of the liquid fuel.

Therefore, a washing device for delivering water in sanitary facilities, in particular in a shower, is optimized according to the present invention, and the present invention represents a cost-effective embodiment of a shower head. The diverse requirements on the spray to be generated may be implemented individually and on the basis of low costs because of the configuration according to the exemplary embodiments and/or exemplary methods of the present invention, in particular through its high degree of geometric freedom. Because of the above-described spray properties, the exemplary embodiments and/or exemplary methods of the present invention is advantageously applicable as a cost-effectively manufacturable concept for shower heads and other applications.

The drawings illustrate an exemplary embodiment of the present invention and schematically shows an atomizer.

### BRIEF DESCRIPTION OF THE DRAWINGS

FIG. 1 shows the machining of a channel-shaped bent atomizer plate having multiple slots in a detail.

FIG. 2 shows the machining of a shell-shaped atomizer plate having the flow pattern at a slot in a detail.

FIG. 3 shows the flow pattern at a slot in a detail of the atomizer plate.

FIG. 4 shows the flow pattern at a slot in a detail of the atomizer plate, and a further catch plate which is mounted upstream in the jet direction.

### DETAILED DESCRIPTION

The atomizer essentially includes an atomizer attachment, which includes at least one atomizer plate 1, which is convexly curved in the jet direction and is inserted into the outlet. At least one slot 2 or multiple slots 2, which are situated in parallel directions to one another, are introduced into atomizer plate 1.

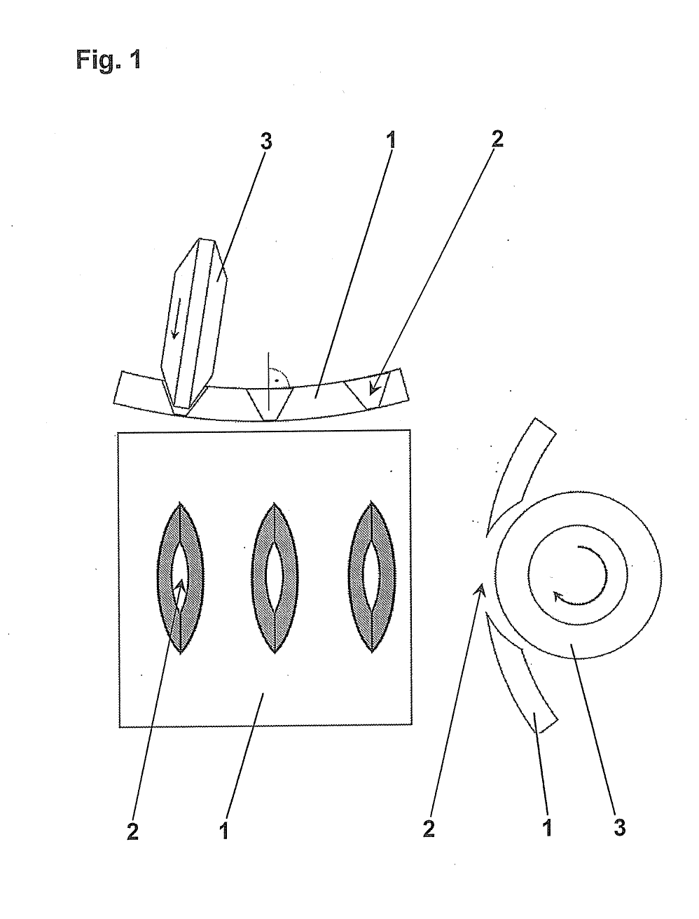

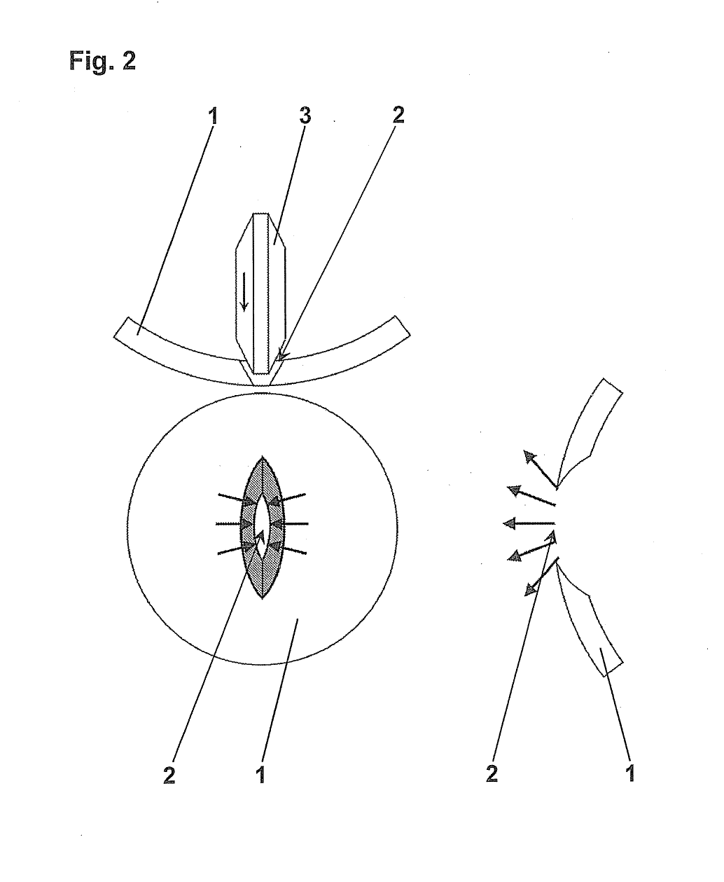

Atomizer plate 1, which is convexly curved in the jet direction, is bent in a channel shape according to FIG. 1 or in a shell shape according to FIG. 2.

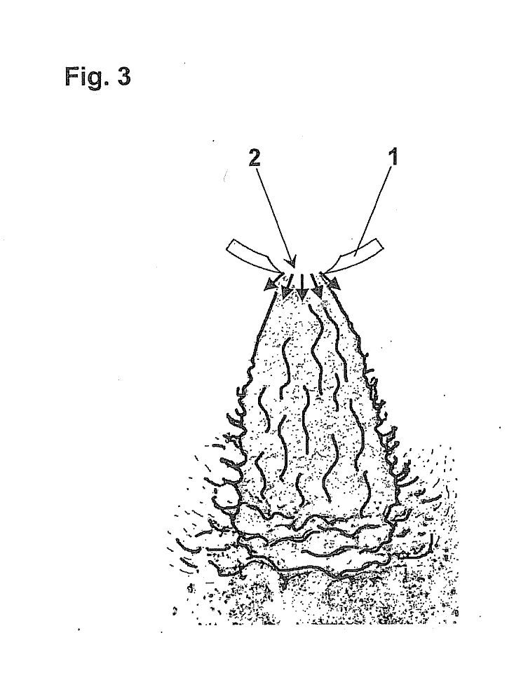

A slot 2 is milled or ground in a curved atomizer plate 1 using a disk-shaped tool 3. The slot cross section thus receives an oblong format having an arbitrary cross-sectional shape. In the exemplary embodiment, a lenticular cross section is achieved using illustrated tool 3, which additionally gradually narrows in the through flow direction. The corresponding flow pattern on an atomizer plate 1 is shown in FIG. 3.

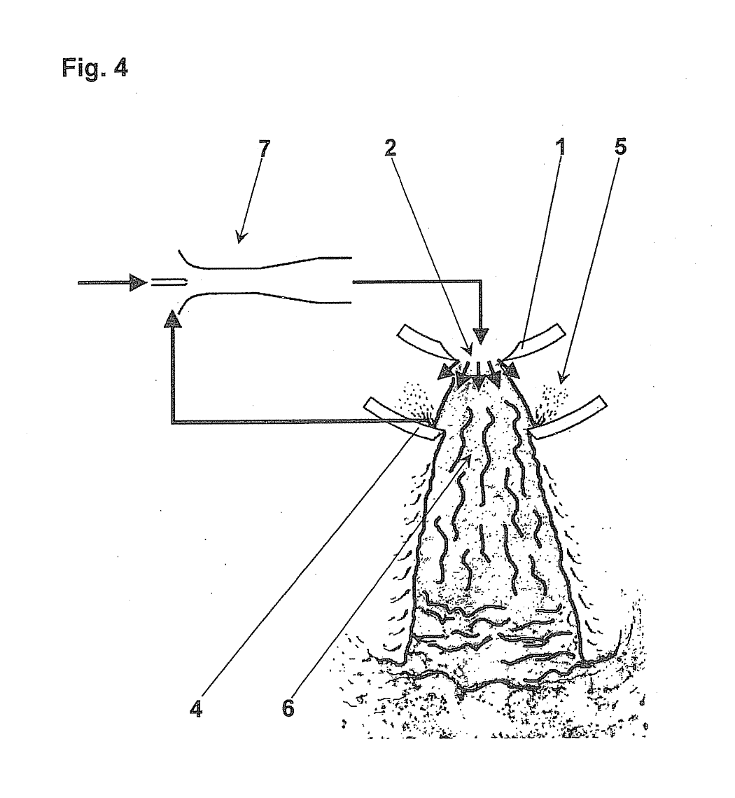

According to FIG. 4, a further catch plate 4 is mounted upstream from atomizer plate 1 in the jet direction. A space is provided between atomizer plate 1 and additional catch plate 4, so that a cavity 5 is formed. Additional catch plate 4 has at least one opening 6, which is associated with a slot 2 in atomizer plate 1, for the passage of the fan-shaped liquid jets in each case, the external dimensions of opening 6 being selected in such a way that the lateral jet edges of each fan jet are prevented from passing by catch plate 4 and the liquid quantity from the jet edges is collected on the upstream side of catch plate 4, i.e., in cavity 5.

This collected liquid quantity from the jet edge is sucked off the catch plate and resupplied to the atomizer. A pump 7 operating according to the injector principle, which is connected upstream from atomizer 1, is provided for the suction.

One fan jet or one liquid lamella exits per slot 2. The spreading of the fan jet is achieved by the narrowing width of slot 2 in the flow direction, whereby flow vectors tapering toward one another are generated transversely to the length of the slot on the two opposing longitudinal sides of slot 2, which impact one another in the slot exit plane. As a reaction to this impact, a divergent flow results on the downstream side of slot 2, whereby a fan jet is spread apart. This corresponds to the flow pattern according to FIG. 3. The spreading is further supported in that atomizer plate 1 is convexly curved in the jet direction along the length of a slot 2.

In the case of more than one slot 2, they spray in divergent directions from one another, whereby the fan jets remain spatially separated from one another in spite of the lamellar oscillations and therefore the entire lamellar packet is well atomized. Because of the atomization principle “lamellar disintegration” and the distribution of the fluid flow to be atomized onto many atomizing openings, a good atomization result is achieved. In the case of sufficiently large directional divergence and contact freedom between the adjacent lamellae, which may be greater than 4°, for example, the ideal atomization quality of an individual lamella is achieved in the lamellar packet, i.e., the entire jet. The mean drop size may be reduced by up to one-third compared to other atomization principles or concepts. If larger drops are desired, they are settable in wide limits in a targeted way by less directional divergence between the lamellae via the resulting lamellar distance.

The atomization quality is additionally settable via that of the individual lamellae. A lesser width of a slot 2 and a smaller radius of curvature along the length of a slot 2 result in smaller drops in the lamella. Through arbitrary configuration and distribution of slots 2 on atomizer plate 1, the sprayed quantity in the lamellar packet may be arbitrarily distributed. Arbitrarily large areas or areas separated from one another may thus be sprayed either using homogeneous or intentionally inhomogeneous spray quantity distribution. The fanning angle of each fan jet is also settable in a targeted way through the arc length of a slot 2. The spray pattern may therefore be limited to arbitrarily contoured small or large areas to be sprayed without high edge losses. These also include, for example, in the case of shower applications, the object of spraying as little water as possible in the area close to or on the shower stall wall.

Fan jets have a high penetration capability as a flat, level formation. They are decelerated little by the atmosphere into which they penetrate. The jet momentum is thus maximally maintained at a given spray distance. The momentum density, is additionally maximally high for cleaning applications because of the flat formation of the fan jet.

1-22. (canceled)

23. An atomizer for liquids, which is for delivering water in a shower, comprising:
an outlet on a liquid supply line for spraying liquids at a low flow rate, the outlet having at least two nozzles for generating liquid jets and for atomizing the liquids; and
at least one atomizer attachment, which includes at least one atomizer plate, which is convexly curved in the jet direction and which is inserted into the outlet, wherein at least one slot or multiple slots are positioned in parallel directions to one another are provided in the atomizer plate.

24. The atomizer of claim 22, wherein the atomizer plate, which is convexly curved in the jet direction, is bent in at least one of a shell shape and a channel shape.

25. The atomizer of claim 22, wherein the slots are configured to at least one of run transversely and diagonally interleaved to the channel axis for the atomizer plate, which is convexly curved in the jet direction.

26. The atomizer of claim 22, wherein the slots are distributed one of equidistantly and at different distances to one another on an atomizer plate, which is convexly curved in the jet direction, and wherein the axes of symmetry of multiple slots, which point in the flow direction, diverge away from one another in the jet direction.

27. The atomizer of claim 22, wherein the slots traverse the thickness of the atomizer plate in the direction of one of a local surface normal and diagonally inclined thereto.

28. The atomizer of claim 22, wherein length of the slots are predefinable and are configured one of identically and differently within at least one of the atomizer attachment and the atomizer plate.

29. The atomizer of claim 22, wherein the slots are situated identically to one another, in a straight slot row, or offset to one another in the slot longitudinal direction.

30. The atomizer of claim 22, wherein the atomizer plate, which is convexly curved in the jet direction is either not curved along the slot row or has a convex curvature in the jet direction, whose radius of curvature is greater than the radius of curvature transversely over the channel-shaped bent atomizer plate.

31. The atomizer of claim 22, wherein one of the following is satisfied: (i) a radius of curvature transversely over the atomizer plate, which is convexly curved in the jet direction, is constant over the length of the slot row, and (ii) a varying radius of curvature is provided over the length of the slot row.

32. The atomizer of claim 22, wherein the atomizer plate, which is convexly curved in the jet direction, is curved rotationally symmetrically or its curvature corresponds to a shell cutout of an ellipsoid.

33. The atomizer of claim 22, wherein a channel-shaped atomizer plate forms a straight channel having a directional divergence between the slot axes, and wherein the slots penetrate the straight channel deviating from the perpendicular to the surface at one location.

34. The atomizer of claim 22, wherein a channel-shaped atomizer plate forms a channel which is convexly curved viewed along its length in the jet direction, the radius of curvature of the convex curvature along the length of the channel being greater than the radius of curvature transversely over the channel, and wherein the slots always run in the direction of the curvature having the smaller radius of curvature.

35. The atomizer of claim 22, wherein a pipe piece, having an outwardly bent surface area is used, is identical in shape to a channel shape and is provided with the slots.

36. The atomizer of claim 22, wherein the width of the slots one of widens and narrows in the jet direction.

37. The atomizer of claim 22, wherein the size of the free slot cross section and the shape of the slot cross section one of vary and remain constant in the jet direction.

38. The atomizer of claim 22, wherein the slot cross-section has an oblong format having an arbitrary cross-sectional shape, which includes one of a rectangular cross-section, a lenticular cross-section, and a oval cross-section.

39. The atomizer of claim 22, wherein another catch plate is mounted upstream from the atomizer plate in the jet direction, and wherein a space is provided between the atomizer plate and the another catch plate, so that a cavity is formed.

40. The atomizer of claim 22, wherein an opening, which is assigned in each case to at least one slot in the atomizer plate, for the passage of the fan-shaped liquid jets is provided in the additional catch plate, and wherein the external dimensions of the opening are selected so that the lateral jet edges of each fan jet are prevented from passing by the catch plate and so that the liquid quantity from the jet edges is collected on the upstream side of the catch plate.

41. The atomizer of claim 22, wherein the catch plate has one of an identical shape and a similar convex shape as the atomizer plate or is implemented as level, and wherein the catch plate is positioned at least far enough away from the atomizer plate so that individual fan jet lamellae disintegrate into smaller ligaments before reaching the catch plate.

42. The atomizer of claim 22, wherein the collected liquid quantity from the jet edge is sucked off the catch plate and resupplied to the atomizer, and wherein one of a pressure boosting pump and a pump which operates according to the injector principle, and which is connected upstream from the atomizer, is provided for the suction.

43. A method for manufacturing an atomizer for liquids, which is for delivering water in a shower, having an outlet on a liquid supply line for spraying liquids at a low flow rate, the outlet having at least two nozzles for generating liquid jets and for atomizing, the method comprising:
one of milling and grinding at least one slot with a disk-shaped tool in at least one atomizer plate, which is convexly curved in the jet direction, of an atomizer attachment, wherein the tool for providing the at least one slot includes a rotationally symmetric, rotating disk.

44. An atomizer for liquids, which is for delivering water in a shower, comprising:
an outlet on a liquid supply line for spraying liquids at a low flow rate, the outlet having at least two nozzles for generating liquid jets and for atomizing the liquids; and
at least one atomizer attachment, which includes at least one atomizer plate, which is convexly curved in the jet direction and which is inserted into the outlet, wherein at least one slot or multiple slots are positioned in parallel directions to one another are provided in the atomizer plate;
wherein the atomizer is used in one of a shower head, a washing and cleaning appliance, firefighting equipment, high-pressure cleaning equipment, furnace and burner technology, and irrigation equipment.
